(19) United States
(12) Patent Application Publication
(10) Pub. No.: US 2005/0104497 A1
(43) Pub. Date: May 19, 2005

(54) Spark plug

(76) Inventors: Jochen Fischer, Bamberg (DE); Andreas Benz, Bamberg (DE)

Correspondence Address: KENYON & KENYON, ONE BROADWAY, NEW YORK, NY, 10004, US

(21) Appl. No.: 10/946,998

(22) Filed: Sep. 22, 2004

(30) Foreign Application Priority Data
Sep. 24, 2003 (DE) 103 44 186.7-23

(51) Int. Cl. H01T 13/20; H01T 13/22

(52) U.S. Cl. 313/144

(57) ABSTRACT

A spark plug includes an insulator situated in a housing, in which the insulator has a sealing surface which lies against a sealing surface of the housing or against a sealing element that is situated between the housing and the sealing surface of the insulator. An arrangement exerts a force on the insulator that is directed in the longitudinal direction of the spark plug in such a way that the sealing surface of the insulator presses upon the sealing surface of the housing or upon the sealing element, and thus the insulator in the housing is sealed in a gastight manner.

### FIELD OF THE INVENTION

The present invention relates to a spark plug.

### BACKGROUND INFORMATION

Such a spark plug is discussed, for example, in German patent document no. 100 36 008. The spark plug includes an insulator that is situated in a housing. A sealing element is provided for sealing, and it is situated between a sealing surface of the housing and a sealing surface of the insulator. For the mounting support of the insulator, the edge of a flange of the housing engages a shoulder of the insulator in such a way that the insulator is clamped between the edge of the flange and the sealing surface.

In this connection, it may be a disadvantage that, when the spark plug heats up, the housing expands more than the insulator, so that, at high temperatures, the insulator is no longer clamped firmly in the housing. This may permit the insulator to become loose in the area of the sealing element, so that the sealing of the spark plug deteriorates.

### SUMMARY OF THE INVENTION

The spark plug according to the present invention has the advantage that good sealing of the insulator in the housing of the spark plug is ensured even at high temperatures. For this, an arrangement is provided that exerts a force on the insulator, directed in the longitudinal direction of the spark plug, in such a way that the sealing surface is pressed against the section of the housing or against the sealing element. It is thereby ensured, even at an increase in temperature, that the sealing surface of the insulator presses with a sufficiently great force against the sealing surface of the housing or against the sealing element. The use of the arrangement thus compensates for the fact that the housing, because of its higher heat coefficient of expansion, expands more than the insulator when the spark plug heats up.

According to an exemplary embodiment of the present invention, the arrangement is a spring element, such as a cylinder spring, a disk spring, a helical spring or as a combination of the spring types mentioned. The spring element may have a spring constant in the range of 0.2 kN/mm to 5 kN/mm, and the spring element exerts a force of at least 500 N at a temperature of 200° C.

According to another exemplary embodiment of the present invention, the arrangement is a compensating element that has a higher heat coefficient of expansion than the housing, and which, at an increase in temperature, exerts a force on the insulator that is directed in the longitudinal direction of the spark plug. Thereby, the compensating element expands more than the housing in response to a heating-up of the spark plug, so that the lesser expansion of the insulator is at least partially compensated for. The heat coefficient of expansion and the geometry of the compensating element should be selected so that, in the region between the compensating element and the sealing surface of the insulator, the sum of the expansion of the compensating element and of the insulator at least largely corresponds to the expansion of the housing in the region of the compensating element up to the sealing surface.

The compensating element may have a heat coefficient of expansion in the range of 20·10⁻⁶K⁻¹ to 30·10⁻⁶K⁻¹ in a temperature range of 0 to 100° C.

The spring element or the compensating element may be provided in a region between the inner wall of the housing and the outer wall of the insulator. With respect to the longitudinal axis of the spark plug, the spring element or the compensating element is situated between an edge of the flange of the housing and a shoulder of the insulator. It is also advantageous if, between the spring element or the compensating element and the edge of the flange and/or between the spring element or the compensating element and the shoulder of the insulator a ring element is provided, which lies in an all-over manner (over the entire surface) against the shoulder or the edge of the flange, and thus ensures a uniform force action on the shoulder or the edge of the flange.

Alternatively, the compensating element or the spring element may be provided on the side facing the combustion chamber, in the area of the sealing surface of the insulator or of the sealing surface of the housing. In this context, the spring element or the compensating element may have a sealing surface which rests on the sealing surface of the insulator and/or of the housing.

The sealing surface of the insulator may lie directly upon the sealing surface of the housing, for the improvement of friction and stability, the sealing surface of the insulator being designed to be glazed, that is, coated with a glaze.

The properties of the spring element may be combined with the properties of the compensating element, i.e. a compensating element is used that has elastic properties at the same time.

### BRIEF DESCRIPTION OF THE DRAWINGS

FIG. 1 shows, as a first exemplary embodiment of the present invention, a spark plug in sectional representation.

FIG. 2 shows, as a second exemplary embodiment of the present invention, a spark plug in sectional representation.

FIG. 3 shows a cutout of a spark plug according to the present invention in the region of the seal between insulator and housing.

### DETAILED DESCRIPTION

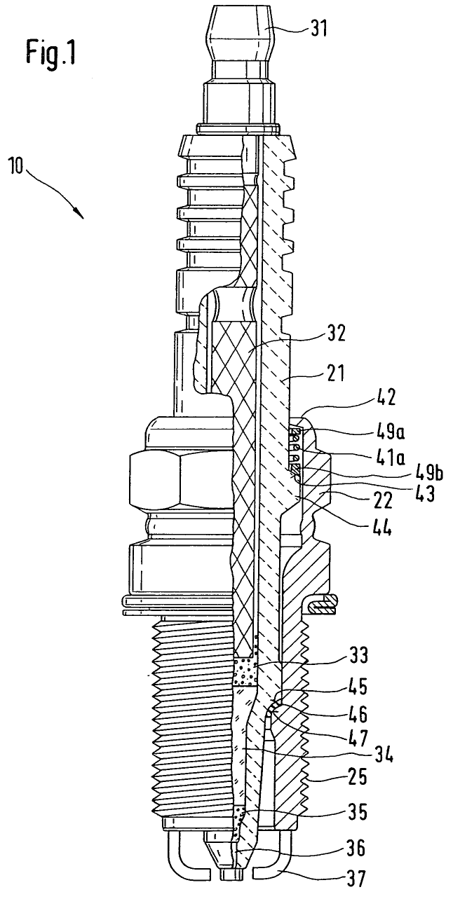

FIG. 1 shows a spark plug 10 which has a housing 22, that is made of metal and is provided with a screw thread 25, with the aid of which spark plug 10 may be screwed into a bore in a cylinder head of an internal combustion engine. On the inside of housing 22 an insulator 21 is accommodated which is made of a sintered ceramic material, such as aluminum oxide. In a longitudinal bore of insulator 21 there are situated a center electrode 36 and a connecting bolt 32 having a section 31 that projects from insulator 21.

Between center electrode 36 and connecting bolt 32, a first contact element 33, resistor element 34 and a second contact element 35 are situated, by which center electrode 36 is conductingly connected to connecting bolt 32. Contact elements 34, 36 are, for example, as a contact panat, and resistor element 35, for example, as a resistor panat.

By the application of a high voltage to connecting bolt 32, a spark current is generated in a known way between center electrode 36 and at least one ground electrode 37 fixed to housing 22, resistor element 35 acting in a current-limiting manner.

A ring-shaped sealing element 46 is provided for sealing insulator 21 in housing 22, which lies on its one side against a sealing surface 45 of insulator 21, and with its other side it lies against a sealing surface 47 of housing 22. Sealing surfaces 45, 47 are each conically shaped surface sections on the outer wall of insulator 21 or on the inner wall of housing 22. Sealing element 46 lies in a planar manner on sealing surface 45 of insulator 21 and sealing surface 47 of housing 22. Sealing element 46 is made of steel or of steel plated with copper.

For a reliable sealing effect it is necessary that sealing surface 45 of insulator 21, in the assembled state, be pressed onto sealing element 46, and thereby sealing element 46 is pressed onto sealing surface 47 of housing 22. For this, a ring-shaped spring element 41 a is provided that encompasses insulator 21. Spring element 41 a is clamped, in a direction parallel to the longitudinal axis of spark plug 10, between an inwards flanged section (flange edge 42) of housing 22 and an outwards extending enlargement of insulator 21 (shoulder 44). Spring element 41 a exerts a force on insulator 21 in the direction of the combustion chamber, so that sealing surface 45 of insulator 21 is pressed onto sealing element 46.

Between spring element 41 a and flange edge 42, a first ring element 49a is provided, and between spring element 41 a and shoulder 44 a second ring element 49b is provided. Because of ring elements 49a, 49b, a uniform pressure is exerted on shoulder 44 of insulator 21. Since the two ring elements 49a, 49b lie flat on the flange edge and/or ring surface 43, of shoulder 44, that faces spring element 41 a, the compressive load per unit area is also reduced.

Spring element 41a is a cylinder spring. In alternative embodiment types that are not shown, spring element 41 is a disk spring or a helical spring. Spring element 41 a has a spring constant of approximately 1 kN/mm, and exerts a force of approximately 1 kN on the insulator at a temperature of 200° C.

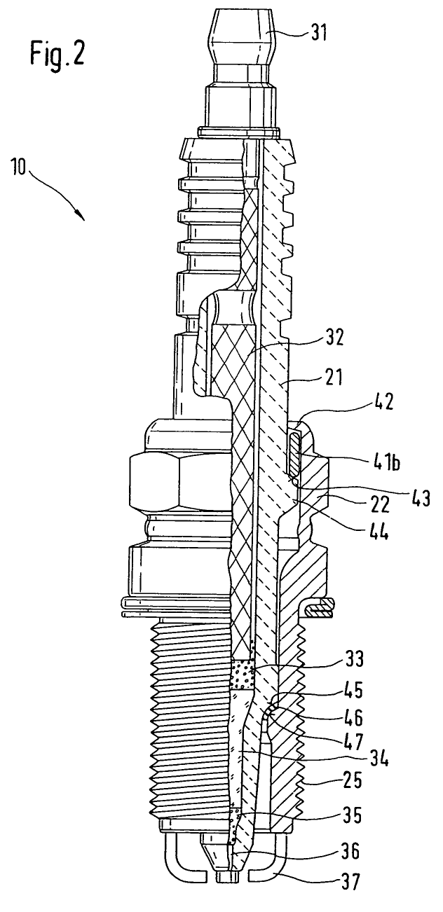

FIG. 2 shows a second exemplary embodiment that, according to FIG. 1, differs from the first exemplary embodiment in that, instead of spring elements, a compensating element 41b is provided, and the first and the second ring elements are omitted. Elements corresponding to one another are marked in the second exemplary embodiment with the same reference symbols as in FIG. 1.

The second exemplary embodiment has a compensating element 41b that is situated between flange edge 42 of housing 22 and shoulder 44 of insulator 21. After the beading of flange edge 42, a section of housing 22 is heated and is rolled over by the application of an axial force. Upon cooling, the heated section of housing 22 shrinks, so that the insulator is clamped between sealing surface 47 of housing 22 and flange edge 42 (via compensating element 41b).

Since housing 22 has a greater heat coefficient of expansion than insulator 21, housing 22 expands more than insulator 21. In order to avoid that thereby the force, with which sealing surface 45 of insulator 21 is pressed against sealing element 46, declines inadmissibly, compensating element 41b is provided. Compensating element 41b has a greater heat coefficient of expansion than housing 22, so that the longitudinal expansion (extension) (that is, the expansion (or extension) along the longitudinal axis of spark plug 10) of housing 22 between flange edge 42 and sealing surface 47 of housing 22 is at least partially compensated for in this region, with respect to the longitudinal expansion of insulator 21. Thereby it is achieved that, even in the case of large temperature increases, the pressure on sealing element 46, and thus the sealing effect, are maintained in adequate measure.

Compensating element 41b is made of an aluminum alloy and has a coefficient of expansion of approximately 23.5·10⁻⁶K⁻¹, while the material of housing 22 has a coefficient of expansion of approximately 10·10⁻⁶K⁻¹ .

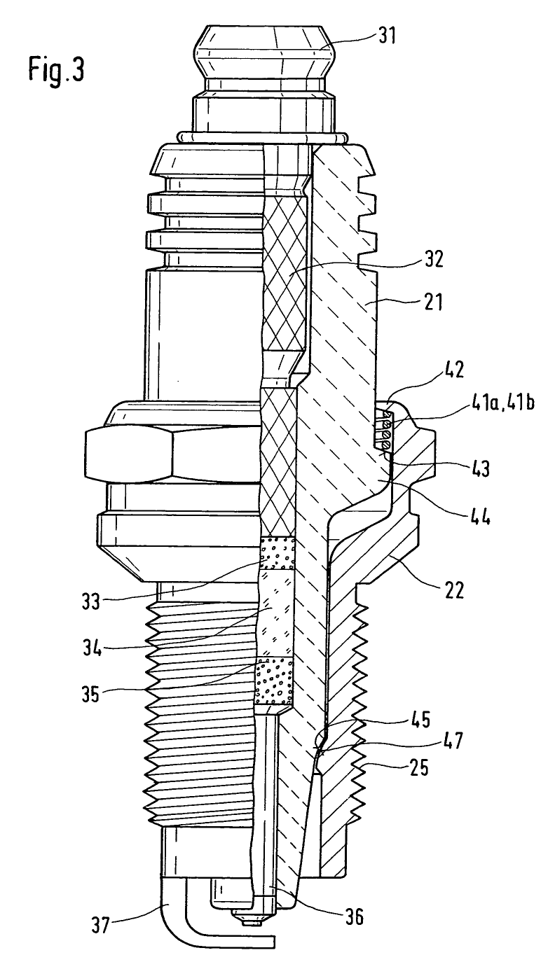

FIG. 3 shows a third exemplary embodiment, which differs from the exemplary embodiments according to FIGS. 1 and 2 by the arrangement of the sealing of the insulator in the housing. Elements corresponding to one another are marked in the third exemplary embodiment with the same reference symbols as in FIGS. 1 and 2.

In spark plug 10 according to FIG. 3, sealing surface 45 of insulator 21 lies directly upon sealing surface 47 of housing 22. Sealing surfaces 45, 47 are pressed against each other by spring element 41a or via compensating element 41b. Sealing surface 45 of insulator 21 is coated with a glazing. Sealing surfaces 45, 47 are conically shaped and have an angle of 12 degrees to the longitudinal axis of spark plug 10.

In the exemplary embodiments described, spring element 41a may simultaneously have the properties of a compensating element, that is, especially, it may have a higher coefficient of expansion than the housing. In the same way, compensating element 41b may have elastic properties like spring element 41a, by reason of the elasticity of the material or by reason of its formation.

1. A spark plug comprising:
an insulator, situated in a housing, which has a sealing surface which lies against one of a sealing surface of the housing and a sealing element situated between the housing and the sealing surface of the insulator; and
an arrangement to exert a force on the insulator that is directed in a longitudinal direction of the spark plug so that the sealing surface of the insulator presses upon one of the sealing surface of the housing and the sealing element, so that the insulator in the housing is sealed in a gastight manner.

2. The spark plug of claim 1, wherein the arrangement is a spring element.

3. The spark plug of claim 2, wherein the spring element is one of a cylinder spring, a disk spring, and a helical spring.

4. The spark plug of claim 2, wherein the spring constant of the spring element is in the range of 0.2 kN/mm to 5 kN/mm.

5. The spark plug of claim 2, wherein the spring element exerts a force of at least 500 N upon the insulator at a temperature of 200 degrees Centigrade.

6. The spark plug of claim 1, wherein the arrangement is a compensating element which has a higher heat coefficient of expansion than the housing, and which, in response to a temperature increase, exerts a force upon the insulator that is directed in the longitudinal direction of the spark plug.

7. The spark plug of claim 6, wherein the compensating element has a heat coefficient of expansion of at least 10·10⁻⁶K⁻¹.

8. The spark plug of claim 6, wherein the compensation element has an aluminum alloy.

9. The spark plug of claim 1, wherein the arrangement is provided in a region between an inner wall of the housing and an outer wall of the insulator.

10. The spark plug of claim 1, wherein the arrangement is situated in the direction of the longitudinal axis of the spark plug, between a section of the housing that projects inwards and a shoulder of the insulator.

11. The spark plug of claim 10, wherein there is at least one ring element at least one of (i) between the arrangement and the section of the housing and (ii) between the arrangement and the shoulder of the insulator at least one ring element.

12. The spark plug of claim 10, wherein the section of the housing is a flange edge.

13. The spark plug of claim 1, wherein the sealing surface of the insulator lies against the sealing surface of the housing, and the sealing surface of the insulator is glazed.

14. The spark plug of claim 13, wherein the sealing surface of the insulator is a conical surface which is at an angle of 5 to 20 degrees to the longitudinal axis of the spark plug.

15. The spark plug of claim 1, wherein the sealing element is a metallic ring that lies upon the sealing surface of the insulator.

16. The spark plug of claim 2, wherein the spring constant of the spring element is about 1 kN/mm.

17. The spark plug of claim 6, wherein the compensating element has a heat coefficient of expansion in the range of 20·10⁻⁶K⁻¹ to 30·10⁻⁶K⁻¹.
